(19) United States
(12) Patent Application Publication
(10) Pub. No.: US 2004/0260557 A1
(43) Pub. Date: Dec. 23, 2004

(54) System and method for voice output from an automation system

(75) Inventor: Carl P. Morse, Milford, NH (US)

Correspondence Address: SQUARE D COMPANY, INTELLECTUAL PROPERTY DEPARTMENT, 1415 SOUTH ROSELLE ROAD, PALATINE, IL, 60067, US

(73) Assignee: Schneider Automation Inc.

(21) Appl. No.: 10/465,101

(22) Filed: Jun. 19, 2003

(51) Int. Cl. G10L 21/00

(52) U.S. Cl. 704/272

(57) ABSTRACT

A voice output system for providing a voice output to a user of a subcomponent of an automation system. A PLC associated with monitoring or controlling an operation of the subcomponent determines if voice output is needed and generates a signal to provide the requisite speech output. The output may be computer generated or a pre-recorded taped message.

### RELATED APPLICATIONS

The present application is being filed concurrently with applications for “System And Method For Voice Input To An Automation System” (Attorney Docket No. SAA-95 (402P311)), Ser. No. ______ unknown at present; “System And Method For Ocular Input To An Automation System” (Attorney Docket No. SAA-96 (402P312)), Ser. No. ______ unknown at present; and “Biometric PLC Access And Control System And Method” (Attorney Docket No. SAA-98 (402P314)), serial number unknown at present; which are incorporated herein by reference. These applications have the same the inventor.

### TECHNICAL FIELD

The present invention is generally related to a system and method for providing voice output from an automation system, and more particularly to a system and method for utilizing speech generated by a subcomponent of an automation system as an output mechanism to provide more detailed information than tones or beeps.

### BACKGROUND OF THE INVENTION

Programmable logic controllers (PLCs) have been used for many years in factory settings to control the execution of numerous independent tasks of one or more devices or pieces of machinery. Such controllers can be configured to be compact, robust and capable of operating in harsh environments that generally deter using a personal computer (PC). In view of these and other attributes, PLCs are a popular choice for implementation in automation systems that are typically located in the factory settings.

PLCs operate in accordance with a stored control program that causes the controller to examine the state of the equipment under its control by evaluating signals from one or more sensing devices. Additionally, PLCs are typically configured to receive input from a user or operator through an IO module or a human-machine interface (HMI).

There are many instances in the factory setting where a user or operator of a device or machine located in the factory, is required to input certain information or control signals during operation of the device or machine. Additionally, there are instances where a user of the system requires information during operation of the system, and is not positioned or otherwise able to view a display panel used for providing text messages to the user. For example, this situation may occur where an operator is utilizing a portion of a machine remote from the control center of the machine, or is required to hold a part in place during operation of the machine. In such circumstances, it becomes necessary for two operators to be present (one to perform the remote task, and one to read the output at the control center display) to effectively operate the machine. This increases the production costs, which are either passed to the consumer or result in lower profitability. In the past, some systems have utilized alarms (e.g., bells, tones, beeps) to provide audible output to the user of the system. However, it is apparent that only limited information can be conveyed by such alarms.

### SUMMARY OF THE INVENTION

The present invention provides a system for providing an audible speech output for a user of a subcomponent of an automation system. The speech output can be utilized to provide information to the user of the subcomponent without requiring the user to be in a position to visually read a display screen at a control center or point in the subcomponent. The system can also be utilized to prompt a response or an action by the user.

In one embodiment of the invention a system for providing voice output for a subcomponent of an automation system comprises a PLC operatively associated with controlling at least one aspect of a subcomponent of an automation system. The PLC is configured to provide an output signal for providing a user of the subcomponent with audible information relating to operation of the subcomponent. The system further includes a speech output device configured to receive the output signal and generate an audible speech output responsive to the output signal.

The voice output system may include a network, for example an Ethernet, for connecting the PLC and the speech output device, as well as other components of the voice output system or automation system. Alternatively, or in combination with a wired network, a wireless connection may be implemented between the PLC and the speech output device (and other components etc.).

The speech output device can provide a prerecorded message audible speech output in response to the output signal, or can be configured to provide a computer generated audible speech output in response to the output signal. In the latter instance, the voice output system can comprise a speech processor for creating the computer generated audible speech output.

The speech output device can comprises a first speaker positioned proximate the subcomponent at a first position. A second speaker can also be positioned proximate the subcomponent at a second location. More speakers can be added depending on the size and shape of the subcomponent. Alternatively, the speech output device can comprise a headphone speaker to be worn by a user of the subcomponent, or other smaller devices carried by the user.

Non limiting examples of subcomponents, machines or automation systems that may utilize the presents invention include stamping machines, conveyor systems, access systems etc.

In another embodiment of the present invention, a system for providing audible speech output for a user of a machine comprises a PLC operatively associated with a machine. The PLC is configured to provide an output signal associated with operation of the machine. The system also includes a speech output device configured to provide audible speech output responsive to the output signal from the PLC. The system can further comprise an I/O module associated with the machine. The I/O module may be configured to receive the output signal from the PLC and provide the output signal to the speech output device. Either a wired network connection or a wireless connection can be used to connect the PLC and the speech output device (as well as any other components).

The speech output device can includes a first speaker positioned proximate the machine at a first location, and/or a second speaker positioned proximate the machine at a second location. Additional, speakers can be placed about the machine as necessary. Alternatively, a user of the system may use headphones or other personally carried speaker.

The system can further comprise a speech processor for converting the output signal into voice data useable by the speech output device.

In yet a further embodiment of the invention, a method for providing audible speech output for a machine in an automation system comprises the steps of providing a PLC connected to a machine, providing a speech processor connected to the PLC, using the PLC to determine if an event in an operation of the machine requires speech output to a user of the machine and, providing a first signal by the PLC to the speech processor for implementing an audible speech output. The method further includes providing a second signal by the speech processor to a speech output device. The step of determining if an event in an operation of the machine requires speech output to a user of the machine can comprise the PLC monitoring the machine for a particular action.

The method can further include positioning the speech output device, such as a speaker, proximate the machine. Alternatively, the method may comprise a user carrying the speech output device. For example, the speech output device can comprise headphones wearable by the user of the machine, or other device that can be carried by the user.

The method can further comprise providing a network connecting the speech processor and the speech output device and, providing voice data from the speech processor to the speech output device over the network. The speech output can be a computer generated voice output, or a prerecorded voice output responsive to the signal from the PLC.

The method can further comprise providing an I/O module for receiving the second signal from the speech processor and providing a third signal to the speech output device. This may further include connecting the speech processor to the I/O module by a network connection.

The step of providing a first signal by the PLC to the speech processor for implementing an audible speech output can comprise sending the first signal to the speech processor over a wireless connection. Similarly, the step of providing a second signal by the speech processor to a speech output device can comprise sending the second signal to the speech output device over a wireless connection.

The machine can be subcomponent of an automation system, such as a stamping machine. The machine can also comprise a conveyor system.

Other systems, methods, features, and advantages of the present invention will be, or will become, apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a timing chart or diagram illustrating the signal processing sequencing or flow of a system in accordance with the present invention; and,

FIG. 2 is block diagram of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspects of the invention to the embodiments illustrated.

The present system is implemented in connection with a machine monitored and/or controlled at least in part by a PLC. Preferably, the machine is a subcomponent of a larger automation system.

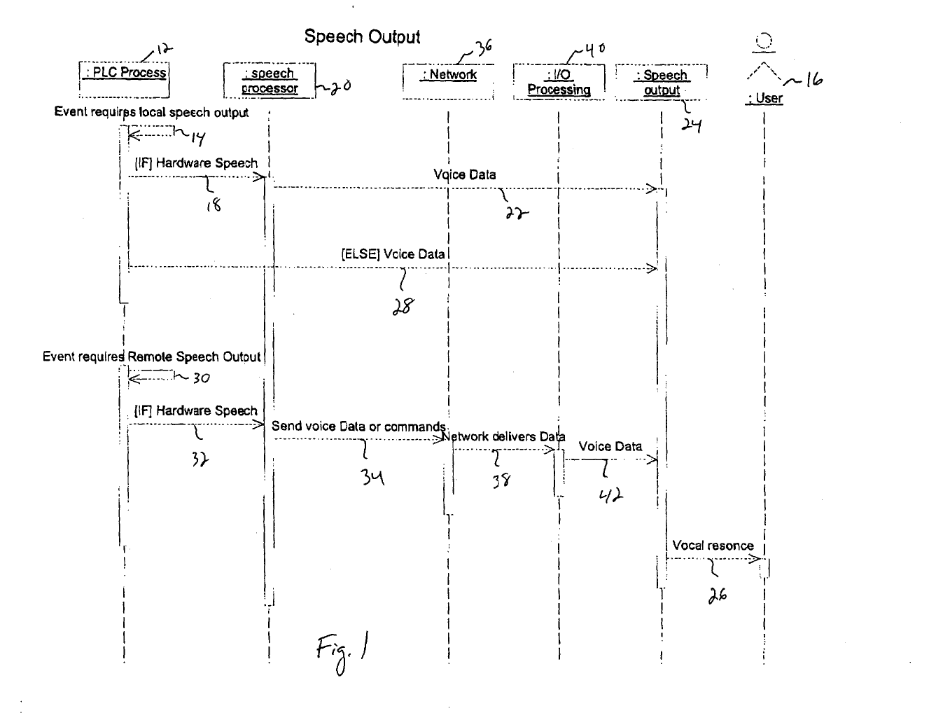

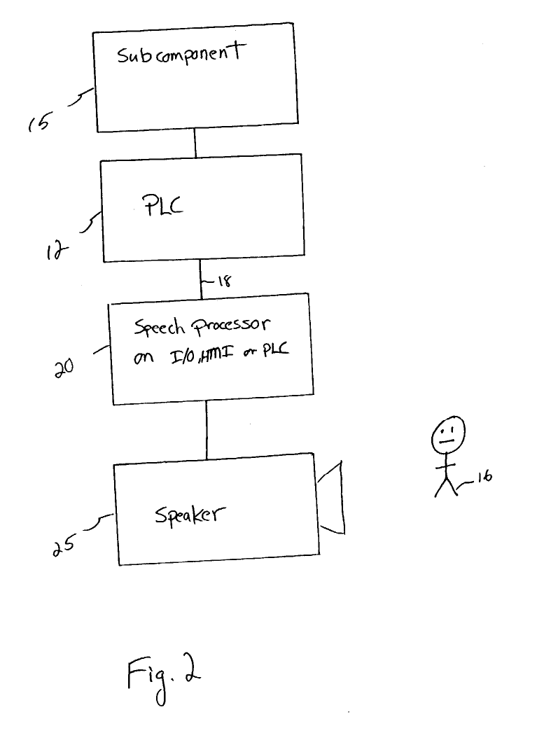

Referring to FIGS. 1 and 2, a PLC 12 monitoring and/or controlling an operation of a machine or other subcomponent 15 of an automation system may determine that an event requires local speech output 14 to a user 16 of the machine. For example, for a machine performing a operation, the PLC may determine that speech output requiring a user to provide a name and password be provided before allowing access to the machine. The speech may be computer generated, or a pre-recorded message maintained on any suitable means (e.g., tape, digital recording etc.).

In the instance where the speech is computer generated, the PLC provides a first signal or command 18 to speech processor 20. The speech processor 20 may be part of an I/O device or an HMI. Alternatively, it may also be part of the PLC. The first signal preferably carries information as to the content of the speech output. However, this may be as little as a number indicating one of a plurality of message types the speech processor can choose from (similarly for pre-recorded messages, the signal may simply identify which of a plurality of messages to play). The speech processor 20 generates a voice data signal 22 which is provided to a speech output device 24. The speech output device 24 then provides an audible speech output 26 for the user 16 of the machine.

The speech output device 24 may include one or more speakers 25 positioned about the machine. The speakers can be wired (e.g., directly, or via the network connection) to the speech output device, or a wireless connection can be utilized. Alternatively, the speech output device may include headphones worn by the user 16, or a portable device carried by the user 16. In this instance, a wireless connection is preferred.

If the system utilizes a pre-recorded voice output, the PLC could send a voice data signal 28 directly to the speech output device 24. The speech output device 24 then plays the appropriate pre-recorded message to generate an audible voice output 26 for the user 16 of the machine. The speech output device 24 can be associated with a plurality of recordings for the voice output.

The PLC 12 may alternatively determine that a remote speech output 30 is required. This may occur in instances were portions of the machine are in two different locations (or that two machine, in two different places, coordinate in the operation). In this case, the PLC may generate a second signal 32 to the speech processor 20 for remote output. The speech processor 20 processes the signal and provides a voice data signal 34 to a network connection 36. The network 36 can be, for example, an Ethernet.

The network 36 delivers the voice data signal 38 to an I/O module 40 associated with a remote location for providing speech output. The I/O module 40 delivers the signal 42 to a speech output device 24 associated with the remote location. The speech output device 24 provides an audible speech output 26 for the user 16. Again, the speech output may be delivered via one or more fixed speakers, or via headphones or other devices carried by the user. Moreover, whether local or remote, the speech output can be supplied to more than one user 16 of the machine.

It should be emphasized that the above-described embodiments of the present invention, particularly, any “preferred@ embodiments, are merely possible examples of implementations, merely setting forth for a clear understanding of the principles of the invention. Many variations and modifications may be made to the above-described embodiment(s) of the invention without substantially departing from the spirit and principles of the invention. All such modifications are intended to be included herein within the scope of this disclosure and the present invention and protected by the following claims.

I claim:

1. A system for providing voice output for a subcomponent of an automation system comprising:
a PLC operatively associated with controlling at least one aspect of a subcomponent of an automation system, the PLC configured to provide an output signal for providing a user of the subcomponent with audible information relating to operation of the subcomponent; and,
a speech output device configured to receive the output signal and generate an audible speech output responsive to the output signal.

2. The system of claim 1, further comprising a network connecting the PLC and the speech output device.

3. The system of claim 1, further comprising a wireless connection between the PLC and the speech output device.

4. The system of claim 1, wherein the speech output device provides a prerecorded message audible speech output in response to the output signal.

5. The system of claim 1, wherein the speech output device provides a computer generated audible speech output in response to the output signal.

6. The system of claim 5, further comprising a speech processor for creating the computer generated audible speech output.

7. The system of claim 1, wherein the speech output device comprises a first speaker positioned proximate the subcomponent at a first position.

8. The system of claim 7, wherein the speech output device comprises a second speaker positioned proximate the subcomponent at a second location.

9. The system of claim 1, wherein the speech output device comprises a headphone speaker to be worn by a user of the subcomponent.

10. The system of claim 1, wherein the subcomponent comprises a stamping machine.

11. The system of claim 1, wherein the system provides a speech output requesting a user's identification.

12. A system for providing audible speech output for a user of a machine comprising:
a PLC operatively associated with a machine, the PLC configured to provide an output signal associated with operation of the machine; and,
a speech output device configured to provide audible speech output responsive to the output signal from the PLC.

13. The system of claim 12, further comprising an I/O module associated with the machine, the I/O module configured to receive the output signal from the PLC and provide the output signal to the speech output device.

14. The system of claim 12, further comprising a network connecting the PLC and the speech output device.

15. The system of claim 12, wherein the speech output device includes a first speaker positioned proximate the machine at a first location.

16. The system of claim 15, wherein the speech output device includes a second speaker positioned proximate the machine at a second location.

17. The system of claim 12, further comprising a speech processor for converting the output signal into voice data useable by the speech output device.

18. The system of claim 12, wherein the speech output device comprises a headphone speaker to be worn by a user of the subcomponent.

19. The system of claim 12, wherein the speech output device is a portable device that can be carried by a user of the subcomponent.

20. The system of claim 12, wherein the system provides an output speech to request a user of the machine to provide a password.

21. A method for providing audible speech output for a machine in an automation system comprising the steps of:
providing a PLC connected to a machine;
providing a speech processor connected to the PLC determining if an event in an operation of the machine requires speech output to a user of the machine; and,
providing a first signal by the PLC to the speech processor for implementing an audible speech output.

22. The method of claim 21, further comprising the step of:
providing a second signal by the speech processor to a speech output device.

23. The method of claim 22, further comprising the step of:
positioning the speech output device proximate the machine.

24. The method of claim 22, wherein the speech output device comprises headphones wearable by the user of the machine.

25. The method of claim 22, wherein the speech output device comprises a speaker.

26. The method of claim 22, further comprising the step of:
providing a network connecting the speech processor and the speech output device; and,
providing voice data from the speech processor to the speech output device over the network.

27. The method of claim 21, wherein the speech output is a computer generated voice output.

28. The method of claim 21, wherein the speech output is a prerecorded voice output responsive to the signal from the PLC.

29. The method of claim 22, further comprising the steps of:
providing an IO module for receiving the second signal from the speech processor and providing a third signal to the speech output device.

30. The method of claim 29, further comprising the step of:
connecting the speech processor to the 10 module by a network.

31. The method of claim 21, wherein providing a first signal by the PLC to the speech processor for implementing an audible speech output comprises sending the first signal to the speech processor over a wireless connection.

32. The method of claim 22, wherein providing a second signal by the speech processor to a speech output device comprises sending the second signal to the speech output device over a wireless connection.

33. The method of claim 21, wherein the machine is a subcomponent of an automation system.

34. The method of claim 21, wherein determining if an event in an operation of the machine requires speech output to a user of the machine comprises the PLC monitoring the machine for the occurrence of a predetermined action.
